(19) United States
(12) Patent Application Publication
(10) Pub. No.: US 2011/0138530 A1
(43) Pub. Date: Jun. 16, 2011

(54) SPA JET

(76) Inventor: WILLIAM GORDON JOHNSON, MEDICINE HAT (CA)

(21) Appl. No.: 12/637,839

(22) Filed: Dec. 15, 2009

(51) Int. Cl. A61H 33/02

(52) U.S. Cl. 4/541.6

(57) ABSTRACT

A spa jet includes a first housing fixedly attached to an exterior surface of a sidewall of the spa basin. At least a first magnet supported by the first housing. A nozzle housing and a blade rotatably supported by the nozzle housing for rotation about an axis of rotation. An electric motor including a stator and a rotor, the rotor is coaxially connected to the bladed for conjoint rotation therewith about the axis of rotation, and the stator is supported by the first housing. At least a second magnetic is supported by the nozzle housing, wherein the nozzle housing is detachably attached to an interior surface of the sidewall of the spa basin by a magnetic attraction force between the at least first magnet and the at least second magnetic with the blade, the rotor, and the stator coaxially aligned along the axis of rotation, whereby the electric motor is operable to rotatingly drive the blade for drawing water into the nozzle housing and for discharging water from the nozzle housing.

### FIELD OF THE INVENTION

The present invention relates generally to spa basins and spa jets, and more particularly, relating to a spa jet having a pumping mechanism removably attachable to an interior surface of a sidewall of a spa basin and a driving mechanism attached to an exterior surface of the sidewall of the spa basin for driving the pumping mechanism to circulate liquid within the spa basin.

### BACKGROUND OF THE INVENTION

There exists many devices having a myriad of constructions that include spa jets for providing a flow of liquid in a basin. Some examples include spa style bathtubs, hot tubs, pedicure or foot spa tubs, among others. It is important for these devices to be periodically sanitized to prevent the growth of harmful bacteria that could infect a person using the device. Some devices require more frequent sanitization than others, and it is important that such devices are simple and quick to sanitize to ensure that proper sanitization methods are followed. Particularly, in the salon industry where pedicure spa tubs are utilized on a daily basis to service many customers in a short period of time.

Unfortunately, often in the salon industry, proper sanitization of pedicure spa tubs after each customer is not properly performed. To ensure proper sanitization of a pedicure spa after customer use, the spa and the spa jet system needs to be completely disassembled and sanitized with a sanitizing solution. It is believed poor sanitization is at least partially due to the construction of spa tubs being difficult and time consuming to disassemble to permit the proper sanitization. Moreover, the construction of conventional spa tubs include holes through the basin of the tub to permit the passage of a motor drive shaft connected to an impeller located on the interior side of the basin. The holes through the basin tend to leak and are prone to the growth of harmful organisms.

Accordingly, there is a need for a new spa jet that promotes following proper sanitization methods, that is easily assembled and disassembled and which eliminates holes through the sidewall of a spa basin for connecting a motor drive shaft to a pump impeller.

### SUMMARY OF THE INVENTION

The instant invention is directed towards a spa jet for use in circulating a liquid within a basin, for example, the basin of a pedicure spa. The spa jet is constructed such that the need to have a motor drive shaft hole through the sidewall of the spa basin is eliminated, is easy to disassemble and assembly, and allows the use of disposable basin liners

To achieve these and other advantages, in general, in one aspect, spa jet for a spa basin is provided. The spa jet includes a first housing fixedly attached to an exterior surface of a sidewall of the spa basin. At least a first magnet supported by the first housing. A nozzle housing and a blade rotatably supported by the nozzle housing for rotation about an axis of rotation. An electric motor including a stator and a rotor, the rotor is coaxially connected to the bladed for conjoint rotation therewith about the axis of rotation, and the stator is supported by the first housing. At least a second magnetic is supported by the nozzle housing, wherein the nozzle housing is detachably attached to an interior surface of the sidewall of the spa basin by a magnetic attraction force between the at least first magnet and the at least second magnetic with the blade, the rotor, and the stator coaxially aligned along the axis of rotation, whereby the electric motor is operable to rotatingly drive the blade for drawing water into the nozzle housing and for discharging water from the nozzle housing.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a is a diagrammatic illustration of an exemplary pedicure spa tub having a basin to which a spa jet constructed in accordance with the principals of the present invention is mounted;

FIG. 2 is a fragmented cross sectional view of the pedicure spa tub illustrating a portion of the basin, a fluid pumping assembly and a driving assembly of the spa jet of FIG. 1;

FIG. 3 is a diagrammatic end view of a blade with a rotor illustrating permanent magnet bulks thereof;

FIG. 4 is a diagrammatic end view of a stator illustrating an array of stator coils; and

FIG. 5 is a diagrammatic perspective view of a nozzle of the spa jet.

### DETAILED DESCRIPTION OF THE INVENTION

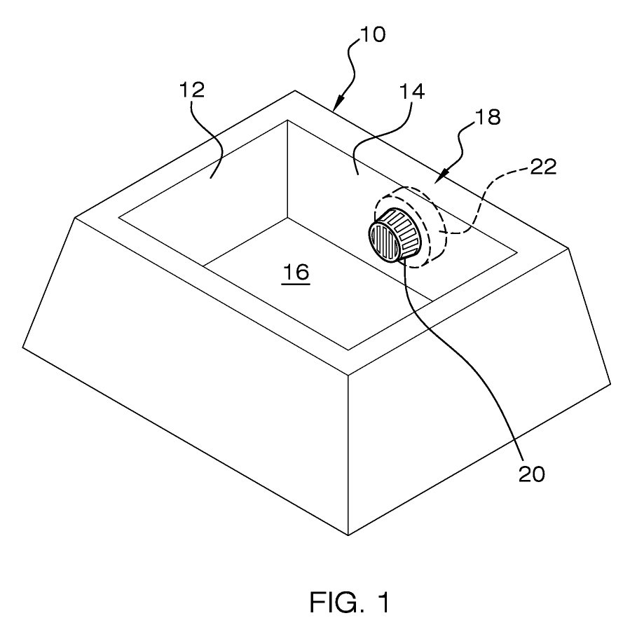

FIG. 1 is a diagrammatic illustration of an exemplary pedicure spa tub 10 having a basin 12 for holding a quantity of liquid, such as water and optionally aromatic, therapeutic, or hygienic ingredients. The basin 12 is defined by a peripheral sidewall 14 and a bottom 16 together form the fluid tight basin for holding the quantity of liquid. The specific configuration of the pedicure spa tub 10 and basin 12 may vary, and the invention is not limited to exemplary configuration shown in FIG. 1. The pedicure spa tub 10 includes one or more spa jets 18 for circulating the liquid within the basin 12. The number, location and configuration of each spa jet 18 may vary, and the invention is not limited to the exemplary configuration shown in FIG. 1. Each spa jet 18 includes a fluid pumping assembly 20 and a driving assembly 22. The pumping assembly 20 and driving assembly 22 are secured to opposing substantially planar surfaces of sidewall 14. However, each of the fluid pumping assembly 20 and the driving assembly 22 can be configured to conform to non-planar surfaces of sidewall 14.

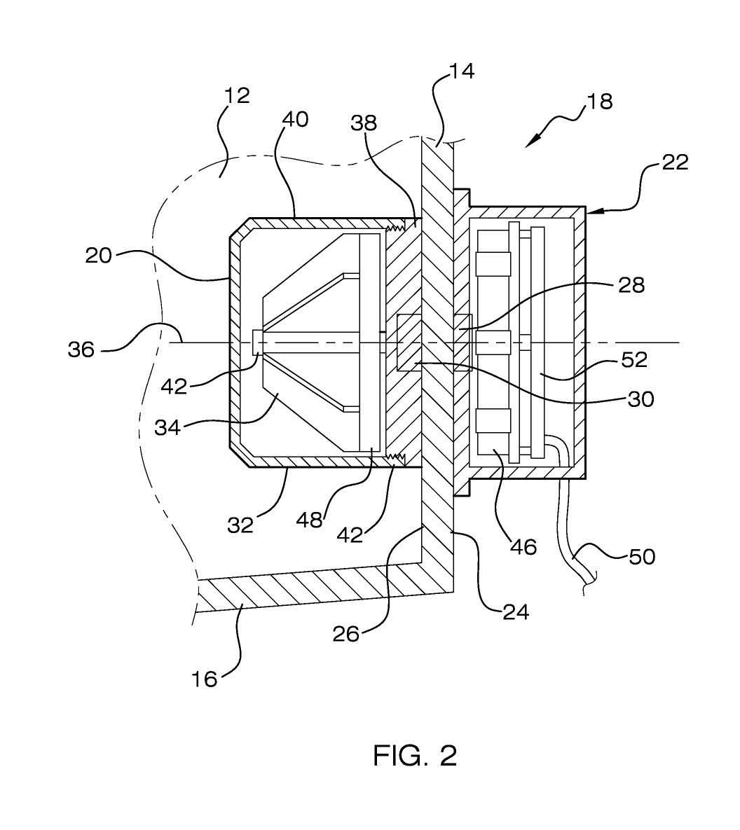

FIG. 2 is a fragmented cross sectional view of the pedicure spa tub 10 illustrating a portion of the basin 12, the fluid pumping assembly 20 and the driving assembly 22. Driving assembly 22 is permanently or semi-permanently affixed to an exterior surface 24 of sidewall 14 with mechanical fasteners, adhesives or the like. Alternatively, driving assembly 22 can be at least partially integral with sidewall 14. The fluid pumping assembly 20 is detachably secured to an interior surface 26 of sidewall 14 at a location opposite from the driving assembly 22. The fluid pumping assembly 20 is positioned so as to be immersed in liquid within the basin 12 to circulate the liquid within the basin during operation. The fluid pumping assembly 20 is detachably secured to the interior surface 26 of the sidewall 14 by a magnetic attraction force between at least one magnet 28 of the driving assembly 22 and at least one magnet 30 of the fluid pumping assembly 20. The magnetic force between magnets 28 and 30 is sufficiently strong to hold the fluid pumping assembly 20 in position during operation of the spa jet 18. The fluid pumping assembly 20 and the driving assembly 22 are each wholly contained and are separated by the sidewall 14 with no portion of either extending through the sidewall. To this end, because there is no direct connection between the fluid pumping assembly 20 and the driving assembly 22, and because the fluid pumping assembly is secured by magnetic force, the fluid pumping assembly may be easily detached and removed from the sidewall 14 of the basin 12 for cleaning and for sanitizing both the fluid pumping assembly and the interior of the basin between uses.

With continued reference to FIG. 2, the pumping assembly 20 includes a nozzle housing 32. A blade 34 is supported by the nozzle housing 32 for rotation about an axis of rotation 36. Blade 34 is illustratively shown, and the invention is not so limited. Thus, the specific configuration of the blade may vary, and may include one or more blades. Nozzle housing 32 may include a fixation base or nozzle housing base 38 to which nozzle 40 is detachably connected, for example by threaded coupling 42. Nozzle 40 is configured to encase and act as a cage around the blade 34 in order to protect a user and a technician during operation, and to direct fluid flow through the pumping assembly 20 as will be discussed further below.

A shaft 42 extends from the nozzle housing base 38, which the blade 34 is rotatably supported for rotation about axis of rotation 36. Blade 34 is supported on shaft 42 without the use of bearings and relies upon a thin film of fluid between the blade and the shaft to reduce friction therebetween.

The driving assembly 22 includes a housing 44 that may include a fixation base 46 for affixing housing 44 to the exterior surface 24 of the sidewall 14 of basin 12. Alternatively, housing 44 may be integral with sidewall 14.

Blade 34 is rotatingly driven about the axis of rotation 36 by an electric motor comprising a stator 46 and a rotor 48. The stator 46 is fixedly supported by housing 44 with the stator axis in coaxial alignment with the axis of rotation 36. The rotor 48 is connected coaxially to the blade 34 for conjoined rotation about the axis of rotation 36. The electric motor is an electrically communicated “pancake” style motor wherein the stator 46 produces an axial magnetic flux that interacts with the permanent magnet bulks of the rotor 48 to rotating drive the rotor, and thus drive the blade 34.

The electric motor is attached to a power supply such as an electrical outlet by a power cord 50, or may be powered by a battery (not shown). An electrical switch, or the like, may be provided to control connect to the power supply. The power cord 50 plugged into an associated electrical outlet may also function as the switch, in that it may simply by plugged in or unplugged in order to control the power supply. Depending on the power source, the power source itself may be disengaged or removed. A controller 52 may be provided for controlling the operation of the electric motor, where the controller may be connected to the power supply and operable to control the excitation of the windings of the stator 46.

In addition, magnets 28 and 30 function to position the pumping mechanism 20 such that the stator 46 and rotor 48 are coaxially aligned. In an aspect, magnet 30 is disposed within a recess 54 defined by nozzle housing base 38, and additionally can be flush with the interior surface 26 of the sidewall 14 of the basin 12. Magnet 28 can be disposed within a recess 56 defined by fixation base 47 defined by housing 44, and additionally can be flush with the exterior surface 24 of the sidewall of the basin 12.

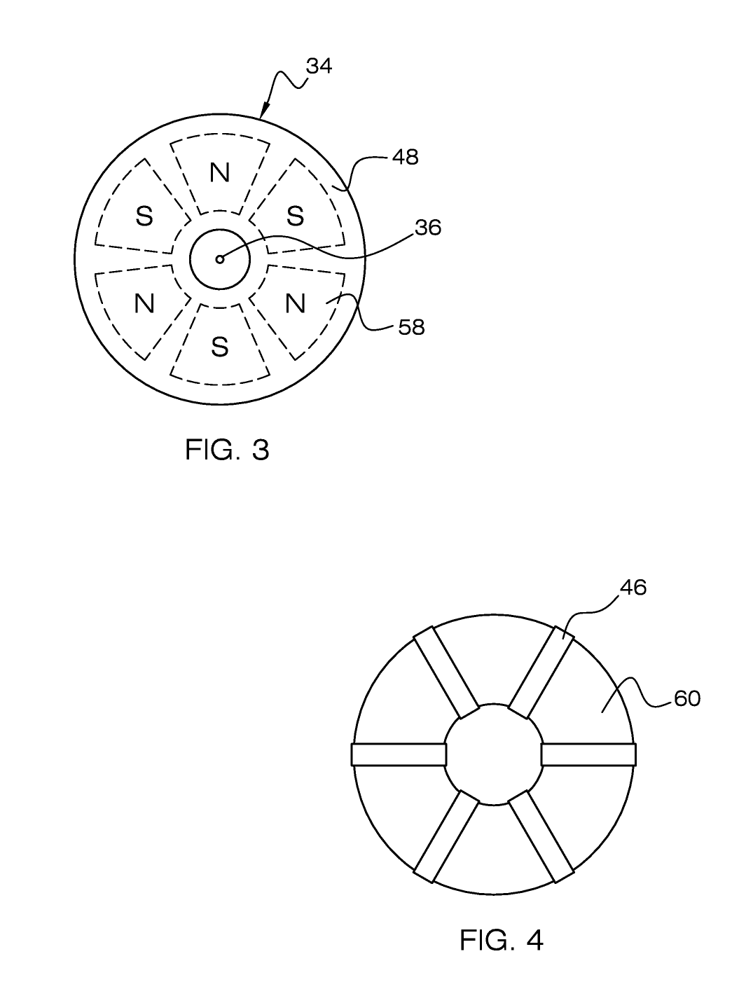

In FIG. 3, there is shown a diagrammatic end view of the blade 34 with the rotor 48 illustrating permanent magnet bulks 58. The permanent magnet bulks 58 include a plurality of pairs of magnetic poles (N) and (S). The magnet bulks 58 are arranged in an equal and opposite fashion, and are arrayed in a radial pattern around the axis of rotor which is coaxial with the axis of rotation 36. In FIG. 4, there is shown a diagrammatic end view of the stator 46 illustrating a radial array of stator coils 60 around the axis of the stator.

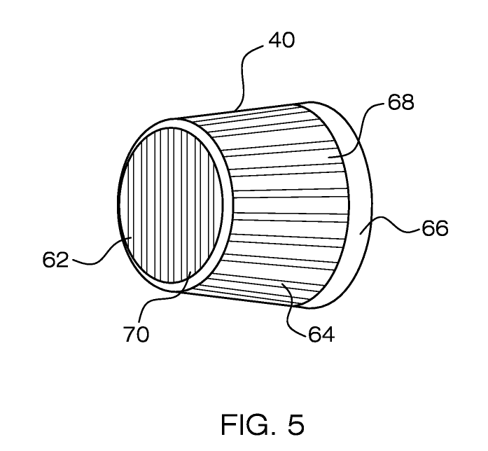

FIG. 5 is a perspective diagrammatic view of the nozzle 40. Nozzle 40, as discussed above, acts a cage around the blade 34, and additionally provides a liquid inlet and a liquid discharge. Nozzle 40 includes a distal end portion 62, a circumferential central portion 64, and a lower end portion 66. Central portion 64 may have a generally cylindrical configuration, and includes a series of through openings or slots 68 therein. Slots 68 extend longitudinally along the nozzle 40 and generally parallel or generally along the axis of rotation 36 of the blade 34. End portion 62 includes a series of through openings of slots 70 therein. Depending upon the configuration of blade 34, slots 68 may act as a liquid intake area and slots 70 may act as a liquid discharge area. Alternatively, blade 34 may be configured such that slots 70 may act as a liquid intake area and slots 68 may act as a liquid discharge area.

The present invention overcomes problems associated with conventional spa fluid jets due to the interconnect between the pumping mechanism 20 and the driving mechanism 22, thereby eliminating the need for holes in the sidewall 14 of the basin 12. Further, positioning all of the rotating members of the spa jet 18 interiorly of the sidewall 14 of the basin 12, which are immersed in liquid in operation, there is virtually no noise emitted from the spa jet. Further, separating the magnetic attachment of the pumping mechanism 20 form the means which operates to drive the blade 34 simplifies construction and prevents rotational torque from dislodging or moving the pumping mechanism 20 from coaxial alignment along the axis of rotation 36.

Spa sanitation is very important, especially in the pedicure spa industry. Because there are no holes in sidewall 14, basin 12 is leak-freak and easier to sanitize. Further, spa jet 18 permits the use of a disposable sanitary liner in basin 12 that can be simply discarded after use further simplifying the sanitation process of basin 12.

While the forgoing description is made in reference to a pedicure spa basin 12, it is important to note the spa jet 18 of the present invention is capable of being used in other configurations requiring water agitation. For example, spa baths, hot tubs, pools, among others, and should not be limited solely for use with a pedicure spa.

Accordingly, a number of embodiments of the present invention have been described. Nevertheless, it will be understood that various modifications may be made without departing from the spirit and scope of the invention. Accordingly, other embodiments are within the scope of the following claims.

What is claimed is:

1. A spa jet for a spa basin, comprising:
a first housing fixedly attached to an exterior surface of a sidewall of the spa basin;
at least a first magnet supported by said first housing;
a nozzle housing;
a blade rotatably supported by said nozzle housing for rotation about an axis of rotation;
an electric motor including a stator and a rotor, said rotor coaxially connected to said bladed for conjoint rotation therewith about said axis of rotation, said stator supported by said first housing; and
at least a second magnetic supported by said nozzle housing, wherein said nozzle housing is detachably attached to an interior surface of the sidewall of the spa basin by a magnetic attraction force between said at least first magnet and said at least second magnetic with said blade, said rotor, and said stator coaxially aligned along said axis of rotation, whereby said electric motor is operable to rotatingly drive said blade for drawing water into said nozzle housing and for discharging water from said nozzle housing.

2. The spa jet of claim 1, wherein said at least a first magnet is juxtaposed the exterior surface of the sidewall of the spa basin.

3. The spa jet of claim 1, wherein said at least a first magnet and said at least a second magnet are positioned along said axis of rotation.

4. The spa jet of claim 1, wherein said blade is one of a propeller and an impeller.

5. The spa jet of claim 1, wherein said nozzle housing comprises a nozzle housing base defining a recess, said at least a second magnet disposed within said recess.

6. The spa jet of claim 1, wherein said nozzle housing base and said nozzle housing are detachably connected.

7. The spa jet of claim 5, further comprising a shaft extending from said nozzle housing base, said blade being rotatably supported on said shaft for rotation about said axis of rotation.

8. The spa jet of claim 1, wherein said nozzle housing includes a distal end portion having a series of openings therein.

9. The spa jet of claim 8, wherein said nozzle includes at least one discharge vent disposed approximate a periphery of said distal end portion, said blade configured as an impeller for drawing liquid through said distal end portion openings toward said impeller and discharging liquid through said at least one discharge vent.

10. The spa jet of claim 1, wherein said at least a second magnet is juxtaposed the interior surface of the sidewall of the spa basin.

11. The spa jet of claim 1, wherein said electric motor is a pancake electric motor.

12. The spa jet of claim 1, further comprising a control circuit for controlling actuation of said electric motor.
